(19) United States
(12) Patent Application Publication
(10) Pub. No.: US 2015/0097986 A1
(43) Pub. Date: Apr. 9, 2015

(54) ITINERARY GENERATION APPARATUS, METHOD, AND NON-TRANSITORY COMPUTER READABLE STORAGE MEDIUM THEREOF

(71) Applicant: Institute For Information Industry, Taipei (TW)

(72) Inventors: Zonyin SHAE, Taipei City (TW); Ko-Yang WANG, Taipei City (TW); Grace LIN, Hualien City (TW); Arthur WANG, Chappaqua, NY (US); Ting-Chieh TU, New Taipei City (TW); Ya-Hui CHAN, Magong City (TW); Meng-Jung SHIH, Guishan Township (TW); Ping-I CHEN, Taipei City (TW); Tai-Chun WANG, New Taipei City (TW)

(73) Assignee: Institute For Information Industry, Taipei (TW)

(21) Appl. No.: 14/086,136

(22) Filed: Nov. 21, 2013

(30) Foreign Application Priority Data
Oct. 9, 2013 (TW) 102136577

(51) Int. Cl. H04N 1/21

(52) U.S. Cl. CPC H04N 1/2133
USPC 348/231.5

(57) ABSTRACT

An itinerary generation apparatus, method, and non-transitory computer readable storage medium thereof are provided. The itinerary generation apparatus includes a storage unit, an interface, and a processing unit, wherein the processing unit is electrically connected to the storage unit and the interface. The storage unit is stored with a piece of information related to a place. The interface is configured to receive a plurality of images, wherein each of the images has a shoot time. The processing unit determines that a portion of the images corresponds to the place according to a piece of schedule information. The processing unit retrieves the piece of information related to the place from the storage unit after determining that the portion corresponds to the place.

### PRIORITY

This application claims priority to Taiwan Patent Application No. 102136577 filed on Oct. 9, 2013, which is hereby incorporated by reference in its entirety.

### FIELD

The present invention relates to an itinerary generation apparatus, an itinerary generation method, and a non-transitory computer readable storage medium thereof; more particularly, the present invention relates to an apparatus, a method, and a non-transitory computer readable storage medium thereof that generate an itinerary according to information related to images.

### BACKGROUND

With the increasingly widespread use of digital cameras, most of people have been accustomed to recording their daily lives by use of the digital cameras. Capturing digital images as records during outings (e.g., tours, business trips or the like) and sharing the digital images after the end of the outings have become a part of these people's lives. Accordingly, a number of service industries related to digital images have appeared.

Producing photo albums is known as one of the common digital image service industries in the market. When a user desires to produce a photo album, he or she needs to upload digital images captured to a website of the service provider. Then, a photo album will be produced automatically by the website in the order of times when the digital images were captured. The user may input by himself information related to contents of the digital images into text fields of the photo album. Once edition of the photo album by the user is completed, a personal photo album that can be printed or viewed online can be produced.

Although it seems that it is convenient to produce a photo album by means of such websites, actually it is not. This is because that such websites only passively provide an environment for the user to edit the digital images. Although these websites order the digital images uploaded by the user, the text edition still relies on the user's input. Actually, the user usually does not know much information about places where he or she has visited during the outgoing, so he or she often does not know what information shall be inputted or even has to look up in a book or a website in order to input accurate information. The large amount of time taken to look up in the book or the website makes it impossible for the user to edit the photo album efficiently. Furthermore, it is often the case that the user fails to taken photos at some places in an outing due to certain factors (e.g., forgetting to take photos, due to bad weathers and etc), which makes the photo album unable to completely present all the information of this outing.

Accordingly, an urgent need exists in the art to provide an itinerary generation technology that allows the user to edit a more complete itinerary in a more efficient way after an outing.

### SUMMARY

To solve the problem of the conventional technologies, the present application discloses an itinerary generation apparatus, an itinerary generation method, and a non-transitory computer readable storage medium thereof.

The itinerary generation apparatus of certain embodiments of the present invention comprises a storage unit, an interface, and a processing unit. The processing unit is electrically connected to the storage unit and the interface. The storage unit is configured to store a piece of place information of a place. The interface is configured to receive a plurality of images, wherein each of the images has a shoot time. The processing unit is configured to determine that a part of the images corresponds to the place according to a piece of schedule information and retrieve the piece of place information from the storage unit after determining that the part of the images corresponds to the place.

The itinerary generation method of certain embodiments of the present invention may be executed by a computer apparatus. The computer apparatus stores a piece of place information of a place. The itinerary generation method comprises the following steps of: (a) receiving a plurality of images, each of which has a shoot time, (b) determining that a part of the images corresponds to the place according to a piece of schedule information, and (c) retrieving the piece of place information after determining that the part of the images corresponds to the place.

The non-transitory computer readable storage medium of certain embodiments of includes a computer program stored therein. The computer program executes an itinerary generation method after being loaded into a computer apparatus. The computer program comprises a code A, a code B, and a code C. The code A is executed by the computer apparatus to receive a plurality of images, each of which has a shoot time. The code B is executed by the computer apparatus to determine that a part of the images corresponds to the place according to a piece of schedule information. The code C is executed by the computer apparatus to retrieve the piece of place information after determining that the part of the images corresponds to the place.

The technology disclosed in the present invention determines that a plurality of images provided by a user corresponds to at least one place according to the shoot times of the images and the schedule information of the user. Once the at least one place corresponding to the images has been determined, the present invention provides the user with at least one piece of place information for reference. When the images provided by the user correspond to a plurality of places, the present invention further calculates a possible dwell time that the user stayed at each of the places and assesses whether it is possible that the user has visited other places. If it is possible that the user may have visited other places, then the present invention further provides the user with images and place information of the places for reference. Therefore, the itinerary generation apparatus, the itinerary generation method or/and the non-transitory computer readable storage medium thereof according to the present invention allow the user to edit a complete itinerary in an efficient way after an outing only by providing the images that he/she has captured.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of an itinerary generation apparatus 1 according to a first embodiment of the present invention;

FIG. 2 is a schematic view of an itinerary generation apparatus 2 according to a second embodiment of the present invention;

FIG. 3 is a schematic view of an itinerary generation apparatus 3 according to a third embodiment of the present invention;

FIG. 4 is a schematic view of an itinerary generation apparatus 4 according to a fourth embodiment of the present invention;

FIG. 5 is a flowchart diagram of an itinerary generation method according to a fifth embodiment of the present invention; and

FIGS. 6A and 6B are a flowchart diagram of an itinerary generation method according to a sixth embodiment of the present invention.

### DETAILED DESCRIPTION

In the following description, an itinerary generation apparatus, an itinerary generation method, and a non-transitory computer readable storage medium thereof will be explained with reference to certain example embodiments. However, these example embodiments are not intended to limit the present invention to any specific examples, embodiments, environment, applications, or particular implementations described in these embodiments. Therefore, description of these example embodiments is only for purpose of illustration rather than to limit the present invention. It should be appreciated that, in the following embodiments and the attached drawings, elements unrelated to the present invention are omitted from depiction.

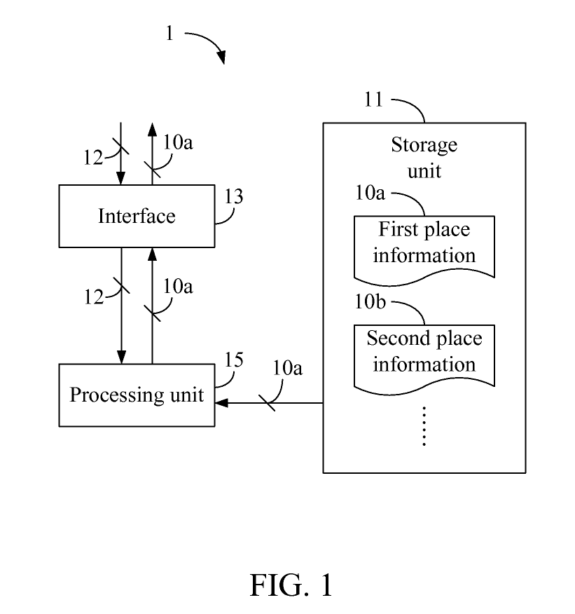

A first embodiment of the present invention is an itinerary generation apparatus 1, a schematic view of which is depicted in FIG. 1. The itinerary generation apparatus 1 comprises a storage unit 11, an interface 13, and a processing unit 15. The processing unit 15 is electrically connected to the storage unit 11 and the interface 13. The storage unit 11 may be a memory, a floppy disk, a hard disk, a compact disk (CD), a mobile disk, a magnetic tape, a database, or any other storage media or circuit with the same function and well known to those skilled in the art. The interface 13 may be any interface capable of receiving and transmitting signals. The processing unit 15 may be any of various processors, central processing units (CPUs), microprocessors or other computing apparatuses that are well known to those skilled in the art.

The storage unit 11 stores pieces of place information respectively corresponding to a plurality of places, e.g., a piece of first place information 10a related to a first place, a piece of second place information 10b related to a second place, and the like. Different places have different pieces of place information. For example, if the aforesaid first place is a tourist spot, then the piece of first place information 10a may be an introduction of the tourist spot. The place information (which comprises the piece of first place information 10a, the piece of second place information 10b, and the like) may be input manually by the administrator of the itinerary generation apparatus 1 in advance and stored in the storage unit 11. Alternatively, the place information (which comprises the piece of first place information 10a, the piece of second place information 10b, and the like) may be produced and stored by the itinerary generation apparatus 1 in an automatic way. For example, the itinerary generation apparatus 1 may search for webpages related to respective places from the Internet through a search engine, and analyze and process the found webpages to obtain the place information (which comprises the piece of first place information 10a, the piece of second place information 10b, and the like). Then, the place information is stored in the processing unit 11. It should be appreciated that the present invention focuses on how to provide services related to itinerary generation by using the place information (which comprises the piece of first place information 10a, the piece of second place information 10b, and the like) stored in the storage unit 11. As to the way that the itinerary generation apparatus 1 obtains the place information (including the piece of first place information 10a, the piece of second place information 10b, and the like), it is not the focus of the present invention.

In this embodiment, if a user transmits a plurality of images 12 captured to the itinerary generation apparatus 1, then the itinerary generation apparatus 1 generates an itinerary related to the images 12 according to the images 12 inputted by the user. Specific operations of the itinerary generation apparatus 1 are described as follows.

The interface 13 receives the images 12 after the images 12 are input by the user. Each of the images 12 has a shoot time. For example, the shoot time of each of the images 12 may be produced by a digital camera or a handheld mobile apparatus (e.g., a mobile phone) when the image 12 is captured. Yet another example, the shoot time of each of the images 12 may be inputted manually by the user. It should be appreciated that the present invention does not focus on the way that the shoot times of the respective images 12 are produced and/or generated. The present invention simply performs subsequent processing according to the shoot times of the respective images 12,

Then, the processing unit 15 compares the shoot times of these images 12 with a piece of schedule information (e.g., a calendar item or a check-in record of a social networking website) of the user to determine that a part of the images 12 (some or all of the images 12) corresponds to the first place. For example, if the calendar item records that the user was to visit the first place within a first time interval and the time interval overlaps the shoot time(s) of a part of the images 12, then the processing unit 15 determines that the part of the images 12 corresponds to the first place. As another example, the processing unit 15 may determine that a check-in time recorded by a check-in record of a social networking website of the user overlaps the shoot times of a part of the images 12, or a time difference therebetween is within a preset range. In any of the two cases, the processing unit 15 determines that the part of the images 12 corresponds to the check-in place (e.g., the first place) of the check-in record of the social networking website.

After determining that a part of the images 12 corresponds to the first place, the processing unit 15 retrieves the piece of first place information 10a of the first place from the storage unit 11 accordingly. Afterwards, the itinerary generation apparatus 1 can provide the user with the piece of first place information 10a through the interface 13 for reference. The itinerary generation apparatus 1 can further provide various different application services in conjunction with this. For example, if the itinerary generation apparatus 1 further provides a service of editing a photo album or a diary, then with reference to the first place information 10a provided by the itinerary generation apparatus 1, the user can decide by himself/herself whether to add the first place information 10a into the photo album or the diary to accompany the captured images 12 so that the contents thereof become more complete.

As can be known from the above descriptions, the itinerary generation apparatus 1 determines the places where the images 12 were captured according to the shoot times of the images 12 and the schedule information of the user. The itinerary generation apparatus 1 retrieves place information related to the places from the storage unit 11 after determining the places where the images 12 were captured. In this way, when the itinerary generation apparatus 1 is used with different application software, more information (i.e., information related with the places where the images 12 were captured) can be used by the user for reference and the user can decide by himself how to use the information. Therefore, services provided by the application software can be used in a more efficient way.

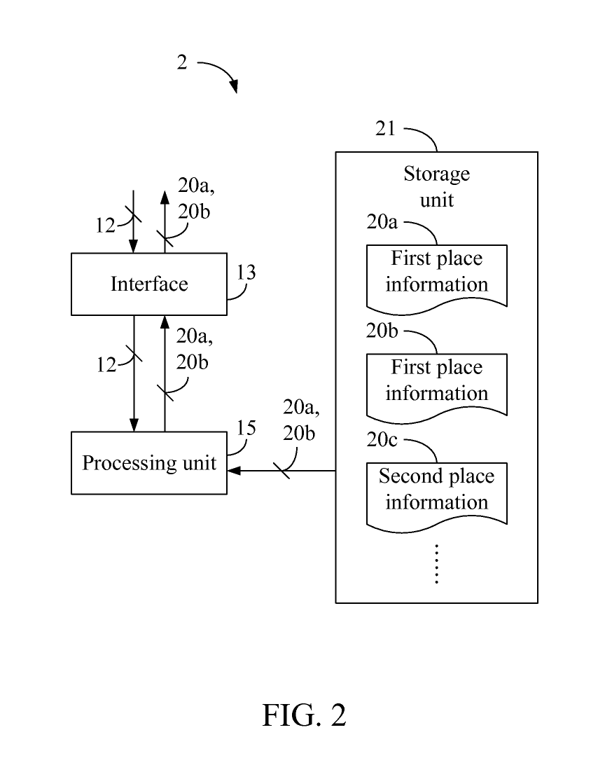

A second embodiment of the present invention is an itinerary generation apparatus 2, a schematic view of which is depicted in FIG. 2. The itinerary generation apparatus 2 comprises a storage unit 21, an interface 13, and a processing unit 15. The processing unit 15 is electrically connected to the storage unit 21 and the interface 13. Similarly, the storage unit 21 may be a memory, a floppy disk, a hard disk, a compact disk (CD), a mobile disk, a magnetic tape, a database, or any other storage media or circuit with the same function and well known to those skilled in the art. Operations of the second embodiment are similar to those of the first embodiment, so only differences therebetween will be described hereinbelow.

The storage unit 21 also stores pieces of place information corresponding to a plurality of places respectively, e.g., pieces of first place information 20a, 20b related to a first place, a piece of second place information 20c related to a second place, and so on. It should be appreciated that some pieces of place information stored in the storage unit 21 are also related to time in this embodiment. For example, the piece of first place information 20a is related to a first time (e.g., in the morning), while the piece of first place information 20b is related to a second time (e.g., at dusk).

Since some pieces of place information are related to time, the processing unit 15 further retrieves the piece of first place information 20a or/and the piece of first place information 20b according to the shoot times of the images 12 corresponding to the first place after determining that a part of the images 12 (some or all of the images 12) corresponds to the first place. For example, if the shoot times of the images 12 corresponding to the first place are in the morning, then the processing unit 15 retrieves the piece of first place information 20a; if the shoot times of the images 12 corresponding to the first place are at dusk, then the processing unit 15 retrieves the piece of first place information 20b; and if the shoot times of the images 12 corresponding to the first place cover both the morning and the dusk, then the processing unit 15 retrieves the pieces of first place information 20a, 20b.

As can be known from the above description, the itinerary generation apparatus 2 retrieves place information related to the places and the time where/when the images were captured according to the place and the time after determining the places where the images 12 were captured. In this way, the place information provided by the itinerary generation apparatus 2 according to the images 12 will become more accurate.

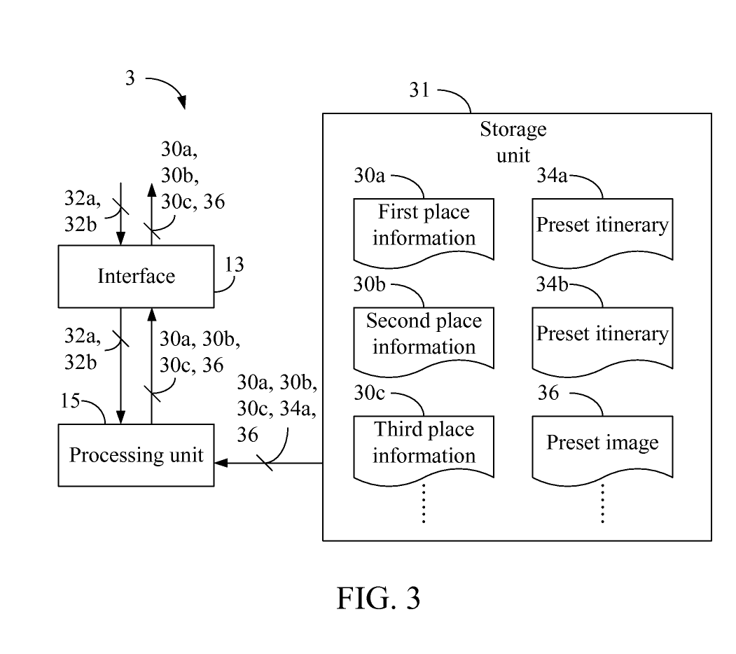

A third embodiment of the present invention is an itinerary generation apparatus 3, a schematic view of which is depicted in FIG. 3. The itinerary generation apparatus 3 comprises a storage unit 31, an interface 13, and a processing unit 15. The processing unit 15 is electrically connected to the storage unit 31 and the interface 13. The storage unit 31 may be a memory, a floppy disk, a hard disk, a compact disk (CD), a mobile disk, a magnetic tape, a database, or any other storage media or circuit with the same function and well known to those skilled in the art. Operations of the third embodiment are similar to those of the first embodiment, so only differences therebetween will be described hereinbelow.

The storage unit 31 stores pieces of place information corresponding to a plurality of places respectively, e.g., a piece of first place information 30a related to a first place, a piece of second place information 30b related to a second place, a piece of third place information 30c related to a third place, and the like. In addition, the storage unit 31 is stored with a preset image 36 of the third place.

Moreover, the storage unit 31 also stores preset itineraries 34a, 34b. Each of the preset itineraries 34a, 34b may be an itinerary suggestion for a certain subject or region. For example, the preset itinerary 34a may be an itinerary suggestion for Tokyo, Japan. The preset itineraries 34a, 34b may be input manually by the administrator of the itinerary generation apparatus 3 in advance and stored in the storage unit 31. Alternatively, the preset itineraries 34a, 34b may be generated and stored automatically by the itinerary generation apparatus 3 using an ontology technology. It should be appreciated that, the present invention focuses on using the preset itineraries (including the preset itineraries 34a, 34b and the like) stored in the storage unit 31 to provide more services related to itinerary generation instead of focusing on how the itinerary generation apparatus 3 obtains the preset itineraries (including the preset itineraries 34a, 34b and the like).

Moreover, the contents of the preset itinerary 34a comprise a first code (not shown), a second code (not shown), and a third code (not shown). The first code corresponds to the first place, the second code corresponds to the second place, and the third code corresponds to the third place. It should be appreciated that the first code, the second code, and the third code may be respectively the names of the first place, the second place, and the third place, or other codes, identification codes and the like that can be used to distinguish the three places. In this embodiment, the first code precedes the third code, while the third code precedes the second code in the preset itinerary 34a. In other words, the itinerary pre-determined by the preset itinerary 34a is sequentially the first place, the third place and the second place. On the other hand, the contents of the preset itinerary 34b comprise other codes corresponding to other places instead of the first code, the second code and the third code described above.

In this embodiment, once a plurality of images (including at least one image 32a and at least one image 32b) is inputted by the user, the images 32a, 32b are received by the interface 13. Similarly, each of the images 32a, 32b has a shoot time. The processing unit 15 compares the shoot times of the images 32a, 32b with a piece of first schedule information of the user to determine that a first part of the images 32a, 32b (e.g., the image 32a) corresponds to the first place. Furthermore, the processing unit 15 compares the shoot times of the images 32a, 32b with a piece of second schedule information of the user to determine that a second part of the images 32a, 32b (e.g., the image 32b) corresponds to the second place.

After determining that the first part (i.e., the image 32a) corresponds to the first place, the processing unit 15 retrieves the piece of first place information 30a corresponding to the first place from the storage unit 31 accordingly. Similarly, after determining that the second part (i.e., the image 32b) corresponds to the second place, the processing unit 15 retrieves the piece of second place information 30b corresponding to the second place from the storage unit 31 accordingly. Afterwards, the itinerary generation apparatus 3 can provide the user with the piece of first place information 30a and the piece of second place information 30b through the interface 13 for reference.

In this embodiment, after determining that the first part corresponds to the first place and the second part corresponds to the second place, the processing unit 15 further retrieves the preset itinerary 34a from the storage unit 31 according to the first code corresponding to the first place and the second code corresponding to the second place.

On the other hand, the processing unit 15 further calculates a first time interval corresponding to the first part (i.e., the image 32a) and a second time interval corresponding to the second part (i.e., the image 32b). The aforesaid first time interval may be considered as a time interval during which the user stayed at the first place as estimated by the processing unit 15, and the aforesaid second time interval may be considered as a time interval during which the user stayed at the second place as estimated by the processing unit 15. For example, the processing unit 15 may take the interval between the shoot time of the first image and the shoot time of the last image in the first part (i.e., the images 32a) as the first time interval, and take the interval between the shoot time of the first image and the shoot time of the last image in the second part (i.e., the images 32b) as the second time interval. As another example, when each of the piece of first schedule information and the piece of second schedule information is a calendar item, the processing unit 15 may take the time interval of the piece of first schedule information as the first time interval corresponding to the first part, and take the time interval of the piece of second schedule information as the second time interval corresponding to the second part.

After calculating the first time interval corresponding to the first part and the second time interval corresponding to the second part, the processing unit 15 further determines whether a third time interval exists between the first time interval and the second time interval. If a third time interval exists between the first time interval and the second time interval, then the processing unit 15 further determines whether a time duration of the third time interval is longer than a journey time taken between the first place and the second place. It should be appreciated that, the journey time may be a preset value, or may be calculated by the processing unit 15 according to traffic conditions between the first place and the second place during the third time interval.

If the time duration of the third time interval is not longer than the journey time taken between the first place and the second place, then the processing unit 15 will not further provide other information. In other words, the processing unit 15 determines that the user has visited only the first place and the second place and assumes the third time interval therebetween as the journey time taken from the first place to the second place. If the time duration of the third time interval is longer than the journey time taken between the first place and the second place, then the processing unit 15 inspects the previously retrieved preset itinerary 34a again. Since there is a third code between the first code and the second code in the preset itinerary 34a, the processing unit 15 retrieves the third code from the preset itinerary 34a. After retrieving the third code, the processing unit 15 retrieves the piece of third place information 30c and the preset image 36 according to the third code. Afterwards, the itinerary generation apparatus 3 can provide the user with the piece of third place information 30c and the preset image 36 through the interface 13 for reference so that the user can decide by himself whether to use the piece of third place information 30c and the preset image 36.

As can be known from the above descriptions, the itinerary generation apparatus 3 determines the place(s) corresponding to the images input by the user and provides place information corresponding to the place(s) in a similar way as the itinerary generation apparatuses 1, 2. In addition, the itinerary generation apparatus 3 further estimates the time duration during which the user stayed at each place according to the images input by the user and the schedule information of the user, and then deduces whether it is possible that the user has visited other places. When it is deduced that the user may have visited other place(s), the itinerary generation apparatus 3 additionally provides the user with information and images related to the place(s) for reference. In this way, if the user fails to taken photos at some place(s) in an outing due to certain factors (e.g., forgetting to take photos, due to bad weathers, etc.), the itinerary generation apparatus 3 can still provide the user with images and place information of the place(s). Thereby, the user can make the itinerary records more complete when editing the itinerary records afterwards.

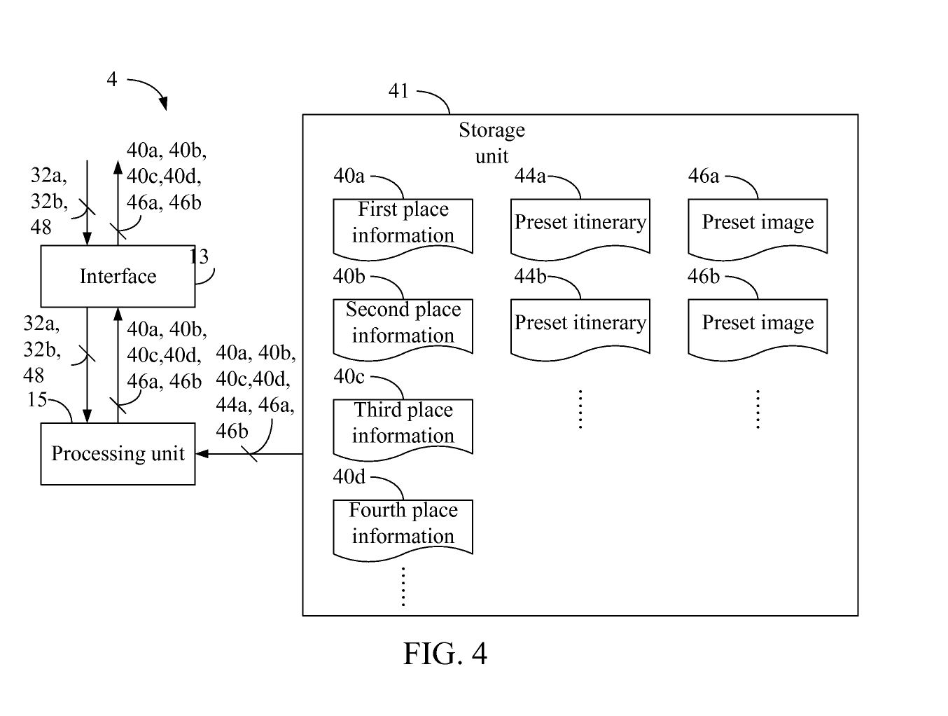

A fourth embodiment of the present invention is an itinerary generation apparatus 4, a schematic view of which is depicted in FIG. 4. The itinerary generation apparatus 4 comprises a storage unit 41, an interface 13, and a processing unit 15. The processing unit 15 is electrically connected to the storage unit 41 and the interface 13. The storage unit 41 may be a memory, a floppy disk, a hard disk, a compact disk (CD), a mobile disk, a magnetic tape, a database, or any other storage media or circuit with the same function and well known to those skilled in the art. Operations of the fourth embodiment are similar to those of the third embodiment, so only differences therebetween will be described hereinbelow.

The storage unit 41 stores pieces of place information corresponding to a plurality of place respectively s, e.g., a piece of first place information 40a related to a first place, a piece of second place information 40b related to a second place, a piece of third place information 40c related to a third place, a piece of fourth place information 40d related to a fourth place, and the like. In addition, the storage unit 41 is stored with a preset image 46a of the third place and a preset image 46b of the fourth place.

Moreover, the storage unit 41 also stores preset itineraries 44a, 44b, each of which corresponds to a group code (not shown). In this embodiment, the group code corresponding to the preset itinerary 44a is different from the group code corresponding to the preset itinerary 44b. Furthermore, the contents of the preset itinerary 44a comprise a first code (not shown), a second code (not shown), a third code (not shown), a fourth code (not shown) and a preset dwell time duration corresponding to each of the codes. The aforesaid first code corresponds to the first place, the second code corresponds to the second place, the third code corresponds to the third place, and the fourth code corresponds to the fourth place. In this embodiment, the first code precedes the third code, the third code precedes the fourth code, and the fourth code precedes the second code in the preset itinerary 44a. In other words, the itinerary pre-determined by the preset itinerary 44a is sequentially the first place, the third place, the fourth place, and the second place.

On the other hand, the contents of the preset itinerary 44b comprise a first code (not shown), a second code (not shown), a fourth code (not shown), and a preset dwell time duration corresponding to each of the codes. In the preset itinerary 44b, the first code precedes the fourth code and the fourth code precedes the second code. In other words, the itinerary pre-determined by the preset itinerary 44b is sequentially the first place, the fourth place and the second place. It should be appreciated that the preset dwell time duration corresponding to a same code may vary in different preset itineraries. For example, the preset dwell time duration corresponding to the first code in the preset itinerary 44a may be different from the preset dwell time duration corresponding to the first code in the preset itinerary 44b.

In this embodiment, the user inputs a user account 48 before inputting the images 32a, 32b. Thus, the images 32a, 32b correspond to the user account 48. The processing unit 15 determines that the user account 48 corresponds to a certain group code after the interface 13 receives the user account 48 and the images 32a, 32b input by the user.

Similarly, the processing unit 15 determines that a first part of the images 32a, 32b corresponds to the first place and a second part of the images 32a, 32b corresponds to the second place, and retrieves the piece of first place information 40a corresponding to the first place and the piece of the second place information 40b corresponding to the second place from the storage unit 41 accordingly.

In this embodiment, the processing unit 15 further retrieves the preset itinerary 44a from the storage unit 41 according to the first code corresponding to the first place, the second code corresponding to the second place, and the group code corresponding to the user account 48. Although each of the preset itineraries 44a, 44b comprises the first code and the second code, the preset itinerary 44a instead of the preset itinerary 44b is retrieved by the processing unit 15 because the group code corresponding to the user account 48 is identical to the group code corresponding to the preset itinerary 44a. Since different group codes may represent different attributes or/and preferences, the processing unit 15 of this embodiment retrieves the preset itinerary 44a as appropriate according to the attribute or/and preference of the user.

Similar to the third embodiment, the processing unit 15 calculates the first time interval corresponding to the first part and the second time interval corresponding to the second part, and determines whether a third time interval exists between the first time interval and the second time interval. If a third time interval exists between the first time interval and the second time interval, then the processing unit 15 further determines whether a time duration of the third time interval is longer than a journey time taken between the first place and the second place. If the time duration of the third time interval is not longer than the journey time taken between the first place and the second place, then the processing unit 15 will not further provide other information. In other words, the processing unit 15 determines that the user has visited only the first place and the second place and assumes the third time interval therebetween as the journey time taken from the first place to the second place.

If the time duration of the third time interval is longer than the journey time taken between the first place and the second place, then the processing unit 15 inspects the previously retrieved preset itinerary 44a again. Since there is a third code and a fourth code between the first code and the second code in the preset itinerary 44a, the processing unit 15 further compares the time duration of the third time interval with the preset dwell time duration corresponding to the third code, compares the time duration of the third time interval with the preset dwell time duration corresponding to the fourth code to further determine whether to retrieve the third code and/or the fourth code from the preset itinerary 44a. For example, if the time duration of the third time interval is close to the preset dwell time duration corresponding to the third code, then the processing unit 15 retrieves the third code from the preset itinerary 44a. As another example, if the processing unit 15 determines that the time duration of the third time interval is much longer than a sum of the preset dwell time duration corresponding to the third code and the preset dwell time duration corresponding to the fourth code, then the processing unit 15 retrieves the third code and the fourth code from the preset itinerary 44a. It should be appreciated that if there are more codes between the first code and the second code in the preset itinerary in other implementations, then the processing unit 15 may also retrieve one or more codes through comparison in a similar way.

In this embodiment, it is assumed that the processing unit 15 retrieves the third code and the fourth code. Afterwards, the processing unit 15 retrieves the piece of third place information 40c and the preset image 46a from the storage unit 41 according to the third code, and retrieves the piece of fourth place information 40d and the preset image 46b from the storage unit 41 according to the fourth code. Afterwards, the itinerary generation apparatus 4 can provide the user with the piece of third place information 40c, the preset image 46a, the piece of fourth place information 40d and the preset image 46b for reference so that the user can decide by himself whether to use the piece of third place information 40c, the preset image 46a, the piece of fourth place information 40d and the preset image 46b.

It should be appreciated that in other implementations, the processing unit 15 may firstly group a plurality of users according to a grouping technology so that users with the same interests belong to a same group and share the same group code. Furthermore, the processing unit 15 may also update the preset itineraries 44a, 44b stored in the storage unit 41 at regular or irregular intervals according to various information of each user (e.g., schedule information or itinerary records completed by the user using the itinerary generation apparatus 4). It should be appreciated that, the present invention focuses on how to use the preset itineraries 44a, 44b to deduce other places that the user may have visited and provide the user with information and images related to the places that the user has visited instead of focusing on how to update the preset itineraries 44a, 44b.

As can be known from the above descriptions, the itinerary generation apparatus 4 deduces other places that the user may have visited according to the attribute or/and preference of the user, which makes the results more accurate.

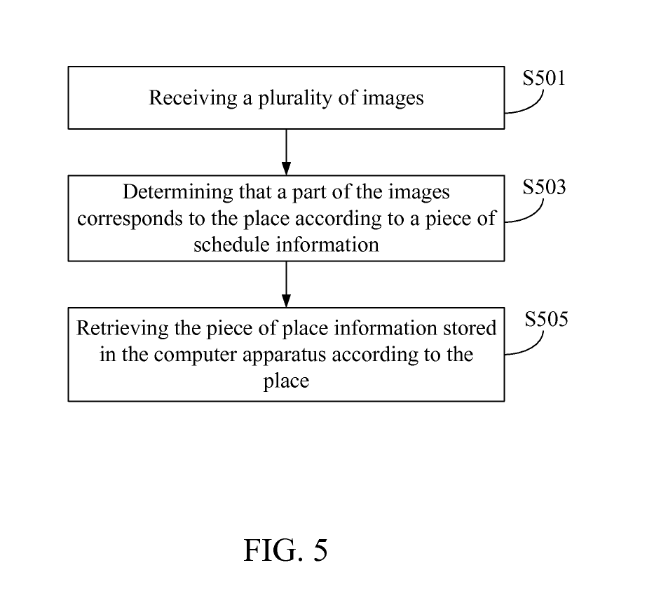

A fifth embodiment of the present invention is an itinerary generation method, a flowchart diagram of which is depicted in FIG. 5. The itinerary generation method is executed by a computer apparatus (e.g., the itinerary generation apparatus 1 or 2), which stores a piece of place information of a place.

Firstly, step S501 is executed to enable the computer apparatus to receive a plurality of images, each of which has a shoot time. Then, step S503 is executed to enable the computer apparatus to determine that a part of the images corresponds to the place according to a piece of schedule information. For example, the piece of schedule information used in the step S503 may be a calendar item, a check-in record of a social networking website or other records comprising schedule information. Afterwards, step S505 is executed to enable the computer apparatus to retrieve the piece of place information stored therein according to the place after determining that the part of the images corresponds to the place. In other implementations, if the piece of place information stored in the computer apparatus is further related to time, then the piece of place information can be retrieved from the computer apparatus according to the place and the at least one shoot time corresponding to the part in the step S505.

In addition to the aforesaid steps, the fifth embodiment can also execute all the operations and functions set forth in the first and the second embodiments. How the fifth embodiment executes these operations and functions will be readily appreciated by those of ordinary skill in the art based on the explanation of the first and the second embodiments, and thus will not be further described herein.

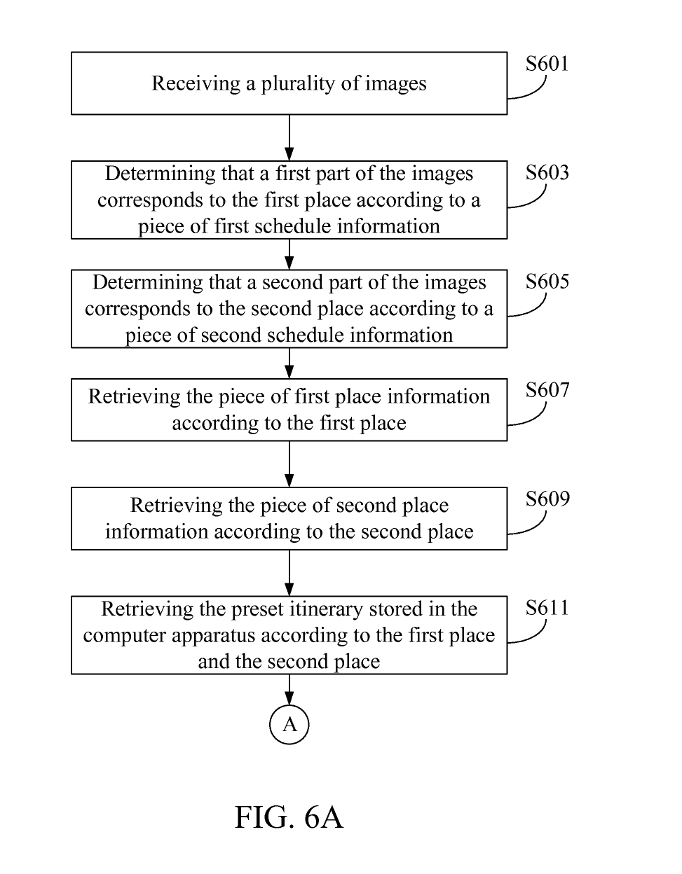

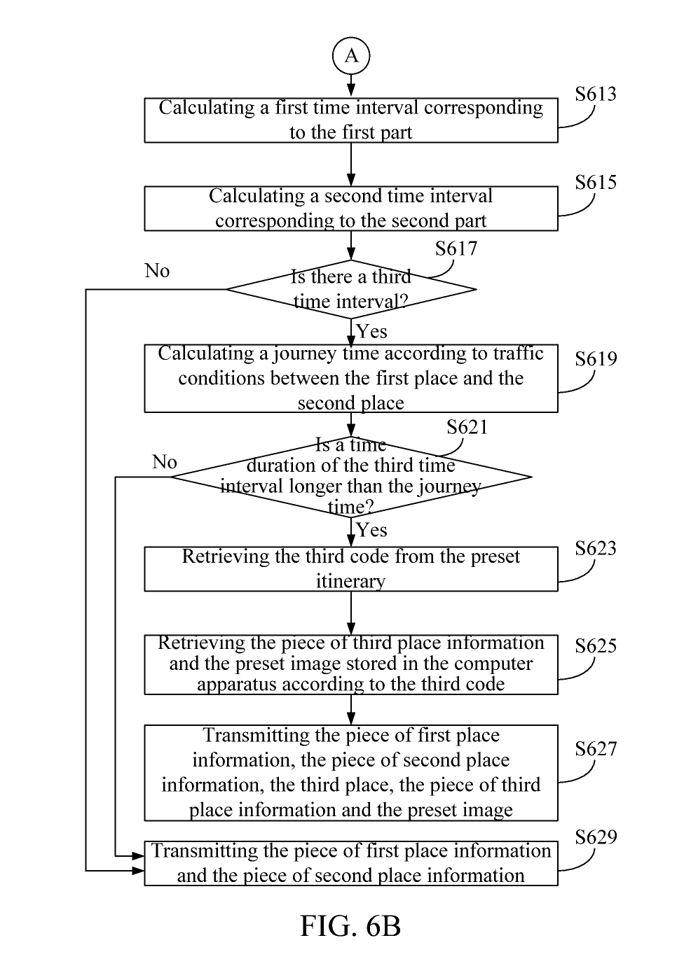

A sixth embodiment of the present invention is an itinerary generation method, a flowchart diagram of which is depicted in FIGS. 6A and 6B. The itinerary generation method is executed by a computer apparatus (e.g., the itinerary generation apparatuses 3, 4).

In this embodiment, the computer apparatus stores a piece of first place information of a first place, a piece of second place information of a second place and a piece of third place information of a third place. In addition, the computer apparatus stores at least one preset image corresponding to the third place. Moreover, the computer apparatus further stores a preset itinerary which comprises a first code, a second code and a third code. The first code corresponds to the first place, the second code corresponds to the second place, and the third code corresponds to the third place. Furthermore, in the preset itinerary, the first code precedes the third code, and the third code precedes the second code.

Firstly, step S601 is executed to enable the computer apparatus to receive a plurality of images, each of which has a shoot time. Then, step S603 is executed to enable the computer apparatus to determine that a first part of the images corresponds to the first place according to a piece of first schedule information. Then, step S605 is executed to enable the computer apparatus to determine that a second part of the images corresponds to the second place according to a piece of second schedule information. It should be appreciated that, the present invention has no limitation on the execution sequence of the step S603 and the step S605, so the two steps can be executed in a reverse order or simultaneously. Afterwards, in step S607, the computer apparatus retrieves the piece of first place information according to the first place. In step S609, the computer apparatus retrieves the piece of second place information according to the second place.

In step S611, the computer apparatus retrieves the preset itinerary stored therein according to the first place and the second place. In step S613, the computer apparatus calculates a first time interval corresponding to the first part. In step S615, the computer apparatus calculates a second time interval corresponding to the second part. It should be appreciated that, the present invention has no limitation on the execution sequence of the step S613 and the step S615, so the two steps can be executed in a reverse order or simultaneously.

Then, in step S617, the computer apparatus determines whether a third time interval exists between the first time interval and the second time interval. If the answer of the step S617 is no, then step S629 is executed to enable the computer apparatus to transmit the piece of first place information and the piece of second place information to the user. If the answer of the step S617 is yes, then step S619 is executed to enable the computer apparatus to calculate a journey time taken between the first place and the second place according to traffic conditions between the first place and the second place. It should be appreciated that, if the computer apparatus is stored with a preset journey time taken between the first place and the second place in other implementations, then the step S619 may be omitted.

In step S621, the computer apparatus determines whether a time duration of the third time interval is longer than the journey time taken between the first place and the second place. If the answer of the step S621 is no, then step S629 is executed to enable the computer apparatus to transmit the piece of first place information and the piece of second place information to the user. If the answer of the step S621 is yes, then step S623 is executed to enable the computer apparatus to retrieve the third code from the preset itinerary. Afterwards, in step S625, the computer apparatus retrieves the piece of third place information and the preset image stored therein according to the third code. Afterwards, step S627 is executed to enable the computer apparatus to transmit the piece of first place information, the piece of second place information, the third place, the piece of third place information and the preset image to the user for reference.

It should be appreciated that, in other implementations, the itinerary generation method may execute a step (not shown) to enable the computer apparatus to receive a user account prior to the step S601. Thus, the images received in the step S601 correspond to the user account. In such implementations, the preset itinerary stored in the computer apparatus may further correspond to a group code. Then in the step S611, the preset itinerary is retrieved according to not only the first place and the second place but also a group code corresponding to the user account. The preset itinerary can be retrieved only when it is determined in the step S611 that the group code corresponding to the user account is identical to the group code of the preset itinerary.

In addition to the aforesaid steps, the sixth embodiment can also execute all the operations and functions set forth in the third and the fourth embodiments. How the sixth embodiment executes these operations and functions will be readily appreciated by those of ordinary skill in the art based on the explanation of the third and the fourth embodiments, and thus will not be further described herein.

Moreover, each of the itinerary generation methods described in the fifth and the sixth embodiments may be implemented by a computer program having a plurality of codes. The computer program is stored in a non-transitory computer readable storage medium. When the computer program is loaded into a processing apparatus and the codes are executed by the processing apparatus, the itinerary generation methods of the above embodiments can be accomplished. The aforesaid non-transitory computer readable storage medium may be a file that can be transmitted via a network, and may also be stored in a tangible machine-readable medium such as a read only memory (ROM), a flash memory, a floppy disk, a hard disk, a compact disk, a mobile disk, a magnetic tape, a database accessible to networks, or any other storage media with the same function and well known to those skilled in the art.

According to the above descriptions, the technology disclosed in the present invention determines that a plurality of images provided by a user corresponds to one or more places according to the shoot times of the images and the schedule information of the user. Once the one or more places corresponding to the images are determined, the present invention can provide the user with one or more pieces of place information that are stored in advance for reference. When the images provided by the user correspond to a plurality of places, the present invention further calculates a possible dwell time during which the user stayed at each of the places and assesses whether it is possible that the user has visited other places. If it is possible that the user has visited other places, then the present invention further provides the user with images and place information of the places for reference. Therefore, the itinerary generation apparatus, the itinerary generation method, and/or the non-transitory computer readable storage medium thereof according to the present invention allow the user to edit a complete itinerary in an efficient way after an outing only by providing the images that he/she has captured.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An itinerary generation apparatus, comprising:
a storage unit, being configured to store a piece of first place information of a first place;
an interface, being configured to receive a plurality of images, each of the images has a shoot time; and
a processing unit electrically connected to the storage unit and the interface, being configured to determine that a first part of the images corresponds to the first place according to a piece of first schedule information and retrieve the piece of first place information from the storage unit after determining that the first part of the images corresponds to the first place.

2. The itinerary generation apparatus as claimed in claim 1, wherein the processing unit retrieves the piece of first place information from the storage unit according to the at least one shoot time corresponding to the first part.

3. The itinerary generation apparatus as claimed in claim 1, wherein the piece of first schedule information is one of a calendar item and a check-in record of a social networking website.

4. The itinerary generation apparatus as claimed in claim 1, wherein the storage unit further stores a piece of second place information of a second place, the processing unit further determines that a second part of the images corresponds to the second place according to a piece of second schedule information, and the processing unit further retrieves the piece of second place information from the storage unit after determining that the second part of the images corresponds to the second place.

5. The itinerary generation apparatus as claimed in claim 4, wherein the storage unit further stores a preset itinerary, the preset itinerary comprises a first code, a second code, and a third code, the first code corresponds to the first place, the second code corresponds to the second place, the third code corresponds to the third place, the first code precedes the third code, the third code precedes the second code, and the processing unit further calculates a first time interval corresponding to the first part, calculates a second time interval corresponding to the second part, determines that a third time interval exists between the first time interval and the second time interval, determines that a time duration of the third time interval is longer than a journey time taken between the first place and the second place, and retrieves the third code from the preset itinerary after determining that the time duration is longer than the journey time.

6. The itinerary generation apparatus as claimed in claim 5, wherein the images correspond to a user account, the preset itinerary corresponds to a group code, and the processing unit further determines that the user account corresponds to the group code and retrieves the preset itinerary from the storage unit according to the group code.

7. The itinerary generation apparatus as claimed in claim 5, wherein the processing unit further calculates the journey time according to a traffic condition between the first place and the second place.

8. The itinerary generation apparatus as claimed in claim 5, wherein the storage unit further stores a piece of third place information and a preset image of the third place, and the processing unit further retrieves the piece of third place information and the preset image according to the third code after retrieving the third code.

9. An itinerary generation method, being executed by a computer apparatus, the computer apparatus storing a piece of first place information of a first place, the itinerary generation method comprising:
(a) receiving a plurality of images, each of the images having a shoot time;
(b) determining that a first part of the images corresponds to the first place according to a piece of first schedule information; and
(c) retrieving the piece of first place information after determining that the first part of the images corresponds to the first place.

10. The itinerary generation method as claimed in claim 9, wherein the step (c) retrieves the piece of first place information according to the at least one shoot time corresponding to the first part.

11. The itinerary generation method as claimed in claim 9, wherein the piece of first schedule information is one of: a calendar item, and a check-in record of a social networking website.

12. The itinerary generation method as claimed in claim 9, wherein the computer apparatus further stores a piece of second place information of a second place, and the itinerary generation method further comprises:
determining that a second part of the images corresponds to the second place according to a piece of second schedule information; and
retrieving the piece of second place information after determining that the second part of the images corresponds to the second place.

13. The itinerary generation method as claimed in claim 12, wherein the computer apparatus further stores a preset itinerary, the preset itinerary comprises a first code, a second code, and a third code, the first code corresponds to the first place, the second code corresponds to the second place, the third code corresponds to the third place, the first code precedes the third code, the third code precedes the second code, and the itinerary generation method further comprises:
calculating a first time interval corresponding to the first part;
calculating a second time interval corresponding to the second part;
determining that a third time interval exists between the first time interval and the second time interval;
determining that a time duration of the third time interval is longer than a journey time taken between the first place and the second place; and
retrieving the third code from the preset itinerary after determining that the time duration is longer than the journey time.

14. The itinerary generation method as claimed in claim 13, wherein the images correspond to a user account, the preset itinerary corresponds to a group code, and the itinerary generation method further comprises:
determining that the user account corresponds to the group code;
wherein the processing apparatus retrieves the preset itinerary according to the group code.

15. The itinerary generation method as claimed in claim 13, further comprising:
calculating the journey time according to a traffic condition between the first place and the second place.

16. The itinerary generation method as claimed in claim 13, wherein the computer apparatus further stores a piece of third place information and a preset image of the third place, and the itinerary generation method further comprises:
retrieving the piece of third place information and the preset image according to the third code after retrieving the third code.

17. A non-transitory computer readable storage medium, having a computer program stored therein, the computer program executing an itinerary generation method after being loaded into a computer apparatus, and the computer program comprising:
a code A for enabling the computer apparatus to receive a plurality of images, each of which has a shoot time;
a code B for enabling the computer apparatus to determine that a part of the images corresponds to the place according to a piece of schedule information; and
a code C for enabling the computer apparatus to retrieve the piece of place information after determining that the part of the images corresponds to the place.
